(19) United States
(12) Patent Application Publication
(10) Pub. No.: US 2004/0129913 A1
(43) Pub. Date: Jul. 8, 2004

(54) Isolation valve with rotatable flange

(76) Inventors: William D. Leonard, Wheaton, IL (US); Chalard Bunluaphob, Glenview, IL (US); Prasert Buranatum, Skokie, IL (US); Daniel E. Schaffer, Schaumburg, IL (US); Lisa E. Hathy-Riles, Wheeling, IL (US)

Correspondence Address: RATNERPRESTIA, P O BOX 980, VALLEY FORGE, PA, 19482-0980, US

(21) Appl. No.: 10/337,498

(22) Filed: Jan. 7, 2003

(51) Int. Cl. F16K 5/06

(52) U.S. Cl. 251/315.01

(57) ABSTRACT

A valve assembly, including a quarter turn ball valve, an insert carried by the valve housing, and a flange, rotatably carried on the insert. The flange is used to secure the valve assembly in a fluid system and the assembly and disassembly of the valve assembly is facilitated by the adjustable position of the flange.

### FIELD OF THE INVENTION

This invention is in the field of valves, and specifically relates to adjustable flanges for securing isolation valves in a fluid system.

### BACKGROUND OF THE INVENTION

The use of circulator pumps to move fluid in closed-loop hot water systems is widespread. When a circulator pump needs to be temporarily removed from the system for repair, replacement, or maintenance, the system must be opened to the atmosphere. This procedure may require the system to be shut down and completely, or at least partially, drained before the pump can be removed. Depending on the size of the system, draining and then refilling, can be a time consuming process. Additionally, shutting down the system during this time may be undesirable.

FIG. 3 illustrates the use of isolation valves 300 to isolate circulator pump 302 from the remainder of the fluid carrying system 304. The use of isolation valves 300 at both the input and the output sides of circulator pump 302 allows the pump to be removed by draining only the pump itself and possibly short connecting pipes. The valves are closed and then the pump can be drained, uncoupled from the system, and removed. The remainder of the system 304 is not drained and may even continue operating at a reduced level with a second pump on a separate loop. In modern installations of hydronic heating systems, such use of isolation valves is common.

Many of the fluid system components for which the use of isolation valves is desirable are heavy and/or cumbersome and in many applications may be located in areas with little space. This may make removal and replacement of these components difficult. Therefore, it is desirable that the process of coupling and uncoupling the isolation valves to the system component be as simple as possible. Mating flanges are commonly used to couple isolation valves to the system components. In order to couple the component to the isolation valves, the bolt holes in the mating flanges must be matched up accurately. This may be difficult in tight spaces with heavy, cumbersome components.

The considerations leading to the desirability of isolation valves are not particular to hot water systems, but they may also be important in systems such as hydraulic (oil) systems, potable water systems, sewage treatment systems, refrigeration systems, and numerous industrial plumbing systems in chemical, and other, manufacturing facilities. In some cases the considerations may be even more important than in hot water systems due to the danger and/or expense attendant to handling the fluids contained within the systems during draining of the fluid. The same considerations also exist for other discreet components in fluid carrying systems, such as filters, hot water heaters, heat exchangers, etc. Therefore, it may also be desirable to couple these other discreet components into their respective fluid carrying systems with isolation valves.

It is desirable for an isolation valve to be designed so that the valve may be simply set in a fully closed or a fully open position. It is also desirable that the condition of the isolation valve (either open or closed) be obvious. If it is not clear whether the valve is open or closed, removal of the isolated component may be attempted with an isolation valve only partially closed, which may lead to leakage of fluid from the system or contamination of the system. Quarter turn ball valves with straight handles have two clearly identifiable positions 90° apart, fully open and fully closed, which may be easily noted by the handle position, parallel to the fluid flow for open and perpendicular to the fluid flow for closed. Valves stops prohibit the quarter turn ball valve from rotating beyond these positions. Therefore, a quarter turn ball valve is preferred for use as an isolation valve.

One isolation valve design has a quarter turn ball valve with a cast flange rigidly integrated into the body of the valve for coupling the isolation valve onto a mating flange of the system component. Although this design desirably includes an easily operated valve design and relatively simple manufacture, the rigid integration of the cast flange requires greater accuracy in order to properly couple the mating flanges. Another design includes a free-floating flange, which is allowed to rotate relative to the valve, but this design includes a ball valve that is allowed to rotate 360° and is operated with either a screwdriver or an allen wrench rather than a handle like a standard quarter turn ball valve. This design makes it difficult to determine with certainty if the isolation valve is fully closed, or fully open.

### SUMMARY OF THE INVENTION

A preferred embodiment of the present invention comprises an isolation valve assembly including a quarter turn ball valve, an insert, and a flange. The quarter turn ball valve includes a housing having inlet and outlet ports. The insert includes a cylindrical body having an axial flow channel. One end of the insert body is coupled to one of the ports of the quarter turn ball valve and the other end of the insert body has a flared lip. The flange has a circular hole, the diameter of which is greater than that of the insert body. The flange is rotatably carried on the outer surface of the insert and is retained thereon by the lip. The flange is also formed with holes adapted to cooperate with fasteners to secure the valve in a piping system.

### BRIEF DESCRIPTION OF THE DRAWINGS

The invention is best understood from the following detailed description when read in connection with the accompanying drawing. It is emphasized that, according to common practice, the various features of the drawing may not be to scale and that the dimensions of the various features may be arbitrarily expanded or reduced for clarity. Included in the drawing are the following figures:

FIG. 1A is an exploded perspective view of a preferred embodiment of an isolation valve assembly with an adjustable flange according to the present invention.

FIG. 1B is a perspective view of the isolation valve assembly shown in FIG. 1A in its assembled condition.

FIG. 2A is a front plan drawing one embodiment of a rotatable flange according to the present invention.

FIG. 2B is a front plan drawing another embodiment of a rotatable flange according to the present invention.

FIG. 2C is a front plan drawing the rotatable flange shown in the embodiment of FIG. 1A.

FIG. 2D is a front plan drawing still another embodiment of a rotatable flange according to the present invention.

FIG. 3 is a block diagram showing the use of isolation valves in a fluid carrying system.

### DETAILED DESCRIPTION

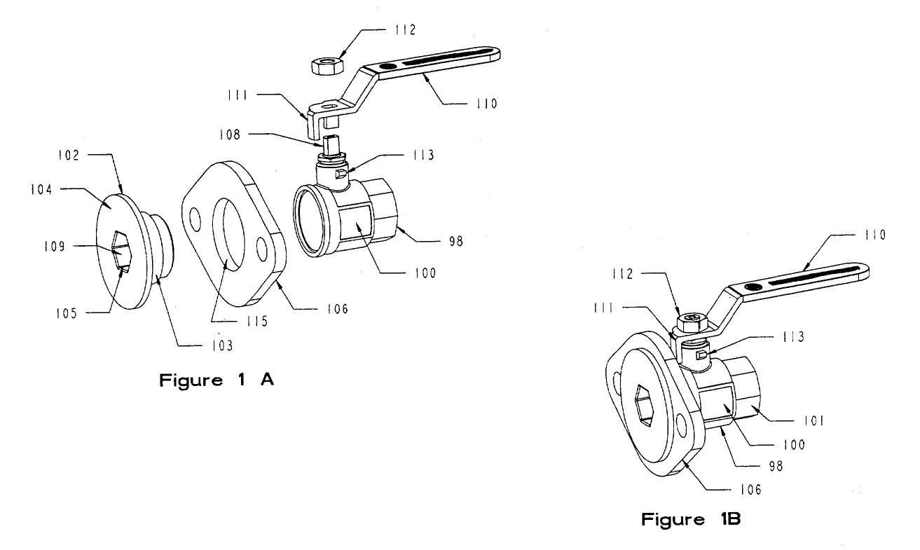

FIGS. 1A and 1B illustrate a valve assembly in accordance with this invention. This valve assembly includes a valve 98, insert 102, and rotatable flange 106. Valve 98 includes a valve body 100 and, as will be understood, both the valve and insert 102 are necessarily in contact with the fluid during operation of the associated fluid system. Therefore, it is desirable for these two parts of the valve assembly to be formed of a material that is unlikely to interact significantly with or contaminate the fluid. For example, in a potable water system valve body 100 and insert 102 may be desirably formed of brass.

The valve 98 is a quarter turn ball valve of any usual construction and, thus, its inner parts are not shown. The housing 100 is formed with inlet and outlet ports and includes a hollow, substantially cylindrical portion aligned with the direction of the fluid flow and forming a flow channel in which a valve seat is formed. Although this substantially cylindrical portion of valve body 100 is shown in FIGS. 1A and 1B as having a circular cross-section, it is contemplated that a section of this portion may have a polygonal exterior surface 101 to accommodate a wrench for coupling valve housing 100 to insert 102 and/or a pipe in the fluid system.

The housing 100 is also formed with a raised cylindrical portion for accommodating the valve mechanism. Stem 108 of the valve extends through this cylindrical housing portion and is connected to handle 110 for opening and closing the valve. Handle 110 is coupled to valve stem 108 by a fastener 112 and includes a skirt 111 extending down the side of the raised cylindrical portion of the housing 100. Shoulders 113 (only one of which is shown) are formed on the raised cylindrical portion and are spaced apart by ninety degrees (90°). The skirt 111 and the shoulders 113 serve to limit the rotation of the handle 110 and thus the valve member between its open and closed position. Any suitable rotation limiting arrangement can be used. Other standard methods to couple handle 110 to valve stem 108 may be used as well.

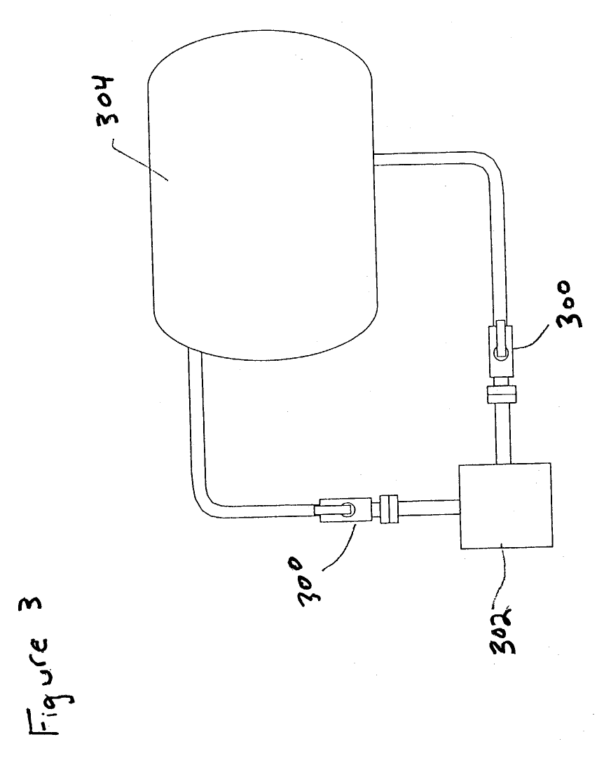

Similar to the isolation valves 300 shown in FIG. 3, the valves 98 are coupled to a pipe system so that once the valves are closed, the component coupled between them may be removed for maintenance, repair, replacement, inspection, etc., without requiring the rest of the system to be drained, or shut down. The interior of one of the inlet or outlet ports, here the inlet port, is internally threaded (adjacent the polygonal exterior 101) so that the valve assembly can be screwed onto a threaded pipe in the associated fluid system. Alternatively, this port interior may be press fitted and/or sweat soldered, or may include a standard coupling flange.

The other port, the outlet port in this embodiment, is coupled to insert 102. Insert 102 has a hole running axially therethrough, functioning as a fluid flow channel 109 that is aligned with the flow channel in the valve housing 100. Insert 102 is shown to have an externally threaded circular section 103 and a polygonal interior section 105 to accommodate a wrench for coupling insert 102 to valve housing 100. The outlet port of valve housing 100 is internally threaded to allow coupling with the threaded section 103 of the insert. Alternatively, the threaded section of insert 102 may be designed to slide into the valve housing body and once inserted may be secured by sweat soldering or other usual means. Press fitting of insert 102 into the aperture of valve body 100 may also be possible.

Before coupling insert 102 to valve housing 100, the threaded end 103 of insert 102 is slipped through the central hole 115 formed in rotatable flange 106. The diameter of hole 115 is such that it snugly, but rotatably fits on the exterior of the insert. The other end of insert 102, that is, the end with the polygonal section 105, includes lip 104. Lip 104 is an annular flange that extends beyond the outer surface of the insert 102 and provides an abutment that serves to prevent rotatable flange 106 from being removed from the assembled valve assembly. Although lip 104 is shown to have a circular cross-section in the embodiment of FIGS. 1A and 1B, it is contemplated that this lip may have other cross-sections and that it need not be continuous. It could include a series of spaced apart fingers that engage the insert.

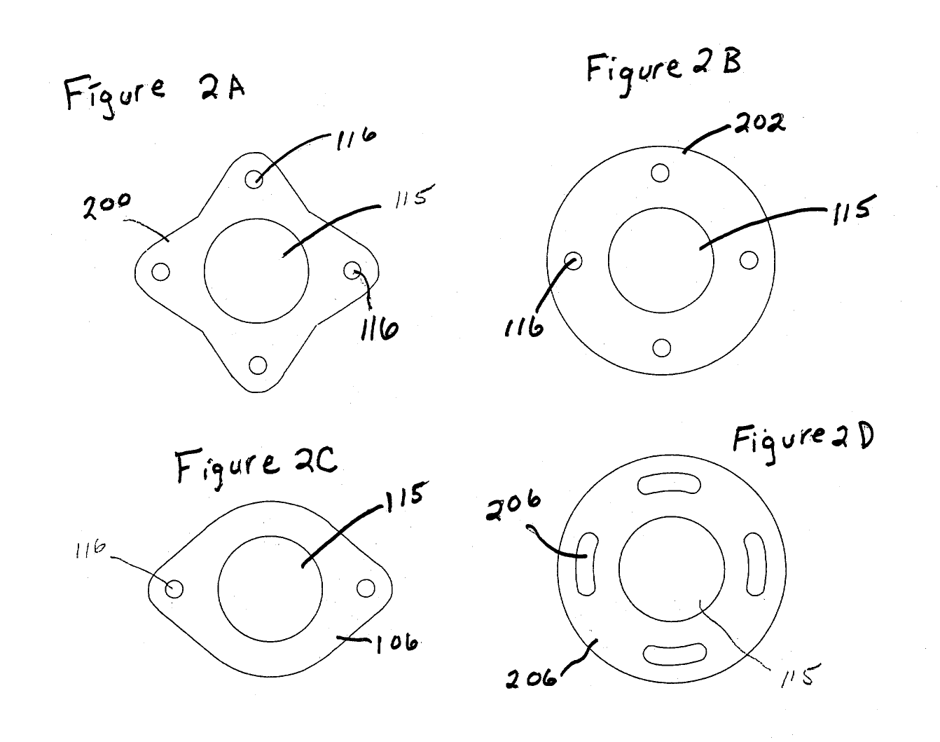

FIGS. 2A-D illustrate end views of four embodiments of rotatable flanges that may be used in the present invention. FIG. 2A shows a four point star shaped flange with one bolt hole 116 in each point of the star. FIG. 2B shows a circular flange with four bolt holes 116 equally spaced around the flange. FIG. 2C shows the diamond shaped flange shown as part of the valve assembly shown in FIGS. 1A-C. This diamond shaped flange has two bolt holes 116 located symmetrically on opposite sides of central hole 208. The flange shown in FIG. 2D is similar to the exemplary flange shown in FIG. 2B, except that bolt holes 116 have been replaced by slots 206. These slots further simplify the coupling of the rotatable flange to its mating flange by accommodating slight misalignments between the slots and the holes in the mating flange. It is noted that, although FIGS. 2B and 2D include four bolt holes or slots, other numbers of holes or bolt slots may be used. It is also noted that the holes or slots are preferably arrange symmetrically around the flange.

These rotatable flanges are flat, stamped metal flanges having central hole 115 located substantially in the center of the flange with either the bolt holes 116 or slots 206 located near the perimeter of the flange to accommodate bolts for coupling the flanges to mating flanges. Strong, durable metals, such as chrome plated steel, are desirable materials for exemplary rotatable flanges. The surface of an exemplary rotatable flange may include a stepped, or beveled, area along the edge of central hole 115 for lip 104 of insert 102 to seat into when the exemplary rotatable flange is coupled to its mating flange

In valve assemblies in which the rotatable flange form a seal directly to its mating flange, rather than the insert forming the seal, the material of the flange is desirably chosen to be a metal which does not significantly interact with the fluid. In such a valve assembly, it may be desirable for the rotatable flange to include a circular groove on its front surface, between central hole 115 and bolt holes 116 and/or bolt slots 206, for an O-ring to improve the seal.

In potable water systems and systems for corrosive fluids, it may be particularly desirable for the flange to remain clear of the fluid path. In these fluid carrying systems, lip 104 of insert 102 is desirably designed to form the seal with a mated pipe or component when the rotatable flange is coupled into the fluid carrying system and the fluid does not come into contact with flange 106. Inserts that are designed to provide a seal as well as holding rotatable flange 106 onto the valve assembly may be formed from a somewhat malleable metal, such as copper or brass, to allow sight deformation during coupling of the rotatable flange to its mating flange, thereby improving the seal. Lip 104 of insert 102 may also include a circular groove on its surface for an O-ring to improve the seal.

While the invention has been described with respect to particular embodiments, those of ordinary skill in the art will appreciate variations in structure and substitutions of materials that are within the scope and spirit of the invention.

What is claimed:

1. A valve assembly comprising:
a quarter turn ball valve including a valve housing having a inlet and outlet ports;
an insert including a flow channel coupled to one of the ports in the housing and a lip formed on its free end; and
a flange rotatably carried on the insert having a circular hole, the diameter of which being greater than that of the insert body and less than that of the valve housing, the flange further having openings for receiving fasteners that secure the assembly in a fluid system.

2. The valve assembly of claim 1, wherein the quarter turn ball valve includes a valve stem coupled to a handle and stop that limit the rotation of the valve stem.

3. The valve assembly of claim 2, wherein the stops include a skirt formed on the handle and shoulders formed on the valve housing that cooperate with the skirt to limit rotation of the valve stem.

4. The valve assembly of claim 1, wherein the insert is formed of brass.

5. The valve assembly of claim 1, wherein the flange is a stamped chrome plated steel flange.
